(19) United States
(12) Patent Application Publication
(10) Pub. No.: US 2025/0031192 A1
(43) Pub. Date: Jan. 23, 2025

(54) MULTIFUNCTIONAL, BUILDING-EDGE WIRELESS ACCESS POINT

(71) Applicant: T-Mobile USA, Inc., Bellevue, WA (US)

(72) Inventors: Jun Liu, Issaquah, WA (US); Egil Gronstad, Encinitas, CA (US)

(21) Appl. No.: 18/356,957

(22) Filed: Jul. 21, 2023

(51) Int. Cl. H04W 72/0453

(52) U.S. Cl. CPC H04W 72/0453; H04W 88/08

(57) ABSTRACT

A wireless access point described herein includes an outside part and an inside part attached on opposite sides of a building's window. The inside part transmits and receives over an unlicensed frequency to one or more devices in the building. The outside part transmits and receives over a radio frequency of a base station of a telecommunications network, transcodes between the radio frequency and the unlicensed frequency, and secures transmissions to the base station across multiple layers of a network stack.

### BACKGROUND

Customer premises equipment (CPE), such as in home routers and cable set-top boxes, their commercial equivalents, and wireless access points installed outside but on or adjacent to a home or office, face challenges. In home CPEs connecting over cable or fiberoptic wired systems transmit data in a password protected manner but otherwise lack additional security. Such cable- or fiberoptic-using CPEs also face hurdles for upgrades as replacing a cable or wire throughout a home and yard may involve extensive work. CPEs connecting to base stations outside of the home or office are often installed external to the premises and may require additional wiring. Such installations may be beyond the ability of a typical home or business owner. Further, transmission over radio frequencies through walls of a building can result in reduced quality of user experience due to interference from those structures.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a diagram of a building with a multipart wireless access point affixed to its window, with an outside part of the wireless access point communicating with a base station over a radio frequency and an inside part communicating with an in-building device over an unlicensed frequency, and with the wireless access point transcoding between the unlicensed frequency and radio frequency and securing transmissions from the wireless access point to the base station.

FIG. 2 is a schematic diagram of an example system architecture of a multipart wireless access point with a part inside a building and a part outside of the building, both attached to a window of the building opposite each other.

FIGS. 3A-3B are flow diagrams of illustrative processes for uplink and downlink transmission, transcoding, and securing by a multipart wireless access point with a part inside a building and a part outside of the building, both attached to a window of the building opposite each other.

### DETAILED DESCRIPTION

This disclosure is directed in part to a wireless access point that includes an outside part and an inside part attached on opposite sides of a building's window. The wireless access point may be a CPE for the building, which may be a home, office, store, or other type of structure. The inside part of the wireless access point transmits and receives over an unlicensed frequency to one or more devices in the building. The outside part transmits and receives over a radio frequency of a base station of a telecommunications network, transcodes between the radio frequency and the unlicensed frequency, and secures transmissions to the base station across multiple layers of a network stack. In other implementations, the inside part rather than the outside part may perform the transcoding, securing, or both.

Both the inside part and the outside part may be affixed to the window by adhesive mechanisms. In some implementations, the inside part and outside part may communicate between each other using one of light emitting and detecting components or laser emitting and detecting components. Such components may be integrated into the inside part and the outside part of the wireless access point.

In some examples, the outside part of the wireless access point receives a transmission from a security camera disposed outside the building as part of the outside part or remote from the outside part. The outside part may then transcode the transmission from the security camera, if needed, for communication towards the device inside the building or towards the base station. If to be communicated towards the base station, the outside part may also secure the transmission from the security camera before sending it on. Further, when the security camera is integrated into the outside part, all transmission prior to sending to the base station is internal to the wireless access point, providing an even greater level of security.

In further implementations, the inside part of the wireless access point may receive a charge through a charging port of the inside part and transmit the charge through the window to the outside part of the wireless access point. The charge may be provided by a battery integrated into the inside part, by a charging cord plugged into an electrical socket, by a cable plugged into another electronic device, or by inductive charge through an inductive charger placed against an outer surface of the inside part.

The wireless access point may also include an Ethernet port (e.g., on the inside part) or a subscriber identity module (SIM) or embedded SIM (eSIM) (integrated in the inside part or the outside part). The Ethernet port may be disposed on a surface of the inside part for wireline communications with a device inside the building. The SIM or eSIM may be configured to provide identity information for the wireless access point to the telecommunications network.

In some implementations, the device inside the building may be a security camera. Security camera(s) may also be integrated in the outside part of the wireless access point or disposed outside of the building. In such implementations, the wireless access point may serve as a hub for a security service for the building. In other examples, the device may be one of a plurality of devices communicating through the wireless access point to the telecommunications network. In such other examples, the outside part of the wireless access point may be configured to prioritize transmissions to or from different ones of the devices based on device types associated with the devices or content types associated with the transmissions. The plurality of devices in such examples may include a security camera, an Internet-of-Things device, a media player, a computing device, or a user equipment (UE).

In various implements, the wireless access point may be managed by an application of a UE. The application may provide set-up guidance for installing the wireless access point. The set-up guidance may include capabilities for identifying signal strengths at possible installation sites around the building. The application may also include capabilities for determining whether a window is suitable for installation.

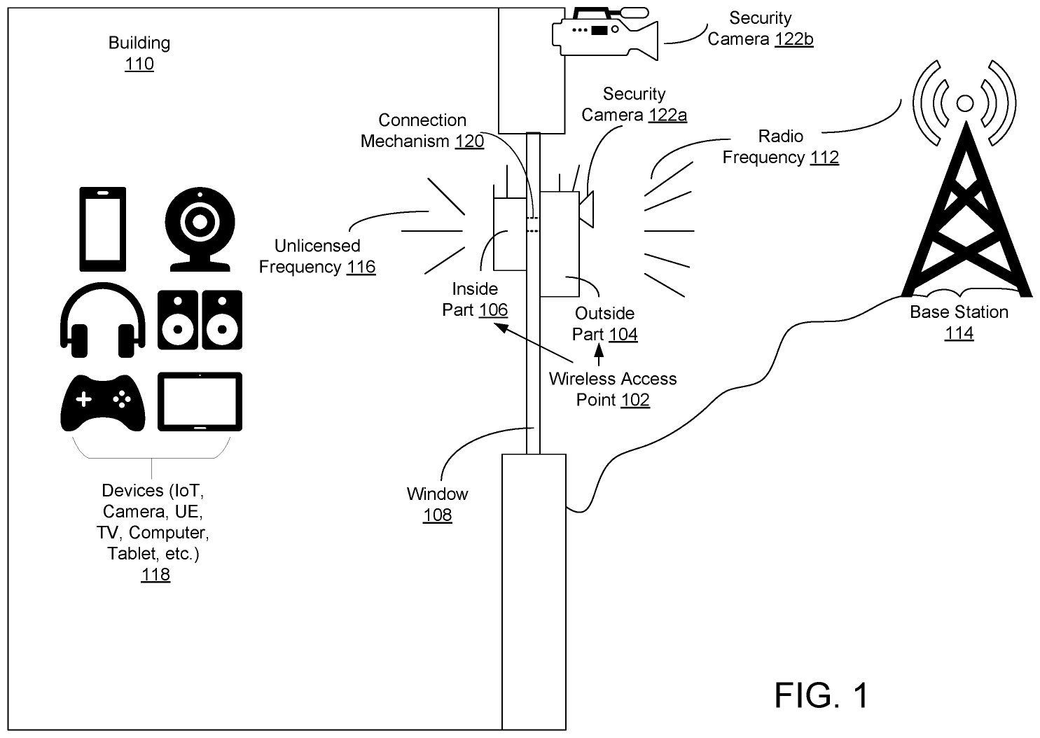

FIG. 1 is a diagram of a building with a multipart wireless access point affixed to its window, with an outside part of the wireless access point communicating with a base station over a radio frequency and an inside part communicating with an in-building device over an unlicensed frequency, and with the wireless access point transcoding between the unlicensed frequency and radio frequency and securing transmissions from the wireless access point to the base station. As illustrated, a wireless access point 102 is comprised on an outside part 104 and an inside part 106, each attached to a window 108 of a building 110 opposite of the other. The inside part 106 is inside the building 110; the outside part 104 is outside of the building 110. The outside part 104 sends and receives over a radio frequency 112 to/from a base station 114 of a telecommunications network. The inside part 106 sends and receives over an unlicensed frequency 116 to/from one or more devices 118 disposed inside the building 110. Also illustrated, the connection mechanism 120 may be light/laser components integrated into each of the inside part 106 and outside part 104 enabling communication through the window 108. Further, the outside part 104 may also receive communications directly from client device, such as security camera 122a or security camera 122b, which are disposed outside of the building 110 (note: while security camera 122a is shown protruding from the outside part 104, it is to be understood that it may be physically integrated within the outside part 104, with only a camera lens on the outer surface of the outside part 104).

In various implementations, the building 110 may be any sort of structure, such as a house, an out-building of a house (e.g., garage, guest quarters, etc.), a store, a factory, an office building, etc. The building 110 may have at least one window 108 and be within range of a base station 114 or repeater or relay device extending a range of the base station 114. The window 108 may be on a ground-level, a second floor, or some higher floor/level of building 110. The window 108 may be double-pained, single-pained, or any other type of window. As noted above, the wireless access point 102 may serve as or in place of CPE for the building 110, replacing such devices as set-top boxes, media consoles, routers, access points, satellites, external CPEs, etc.

In some implementations, the base station 114 of the telecommunications network may be any sort of base station or wireless access point connected to other devices of the telecommunications network via, e.g., wired or wireless backhaul. The base station 114 may represent a single device or multiple devices (e.g., a base station and relay/extender, a macrocell device and a femtocell device, etc.). It may include one or more antennae for radio frequency communications over, e.g., radio frequency 112. Further, the base station 114 may be of any generation of technology (e.g., Third Generation (3G), Fourth Generation (4G), Fifth Generation (5G), Sixth Generation (6G), or later generation) and may be, for instance, an eNode B (eNB) or a gNode B (gNB).

As shown in FIG. 1, devices 118 and security camera 122b may be disposed inside or outside of the building 110, and security camera 122a may be integrated into the outside part 104 of the wireless access point 102. The devices 118 inside of the building 110 may be in any locations within the building 110 and may each communicate over an unlicensed frequency 116, such as a Wi-Fi/802.11 frequency or a Bluetooth frequency. Any unlicensed frequency, however, may be used as unlicensed frequency 116. In some implementations, the inside part 106 may be configured to transmit on multiple unlicensed frequencies 116 at a same time or at different times. The devices 118 may include a security camera, an Internet-of-Things device, a media player, a television (TV), speakers, headphones, a gaming device, a tablet computer, a computing device, or a UE. In some examples, they may communicate with the inside part 106 over the unlicensed frequency 116 though one or more repeater/relay devices disposed in the building 110.

Devices outside of the building and remote from the outside part 104, such as security camera 122b may communicate directly with the outside part 104 over the radio frequency 112. In other implementations, however, such devices may communicate with the outside part 104 over a different frequency, such as unlicensed frequency 116 or a different radio frequency. Devices integrated into the outside part 104, such as security camera 122a, may communicate using wired/electrical/mechanical transmission mechanisms with the wireless access point 102.

In various implementations, the inside part 106 and outside part 104 are each affixed to the window 108 using, e.g., an adhesive mechanism. The inside part 106 and outside part 104 are positioned opposite each other in a particular alignment to enable the connection mechanism 120 to communicate via light/laser and to allow charge to be conveyed from the inside part 106 to the outside part 104 though the window 108. Each of the inside part 106 and outside part 104 may be of any size, so long as not too large for the window 108, and need not be the same size as each other. Each of the inside part 106 and outside part 104 may have external antennae (or not), input/output devices (or not), and, on a window-facing surface, components for emitting/detecting light/laser and for conveying charge. The inside part 106 may also include one or more external ports, such as an Ethernet port, a charge port, a peripheral device jack/port, etc. In some examples, the inside part 106 may also include a removable, rechargeable battery or disposable batteries.

In some implementations, the outside part 104 communicates with the base station 114 over radio frequency 112. Radio frequency 112 may be any sort of frequency band, such as licensed, unlicensed, CBRS, etc. In one embodiment, radio frequency 112 may be a same frequency as unlicensed frequency 116. The outside part 104 however, may be configured to communicate over a range of radio frequencies 112 of multiple types. In some examples, the outside part 104 may be capable of communicating via carrier aggregation, etc. In further examples, the outside part 104 may also be able to communicate with other devices, such as security camera 122, that are disposed outside of the building 110. Such communication may also use the radio frequency 112 or may use a different frequency (e.g., unlicensed frequency 116 or other, different frequency).

As described herein, the inside part 106 may communicate with devices 118 over an unlicensed frequency 116, such as WiFi or Bluetooth. The inside part 106 may send and receive over that frequency. Also, the inside part 106 may include Ethernet port(s) and other wired jacks/ports to support wired communication between the inside part 106 and the devices 118.

While devices 118 communicate with inside part 106, inside part 104 with outside part 104, and outside part 104 with the base station 114, the ultimate endpoints of such communications may be the devices 118 and other devices accessible through or part of the telecommunications network. The telecommunications network may give different priorities to different types of the devices 118 or different types of content of the devices 118, and the inside part 106, outside part 104, or both may utilize those priorities in the manner that data transmissions are prioritized within the wireless access point 102 and in transmissions sent for it.

In some implementations, the unlicensed frequency 116 and radio frequency 112 are different frequencies and a transcoder implemented in the outside part 104, inside part 106, or both may transcode between the inbound one of the unlicensed frequency 116 and radio frequency 112 and the outbound other of the unlicensed frequency 116 and radio frequency 112. Further, after transcoding, the transmission, when outbound from the building 110 for transmission over the radio frequency 112, may be secured across multiple layers of a network stack, such as a physical layer, a link layer, a network layer, an application layer, etc. Such securing effectively places the transmission within a firewall of the telecommunications network. Even greater security is obtained when the transmission comes from the security camera 122a, which is physically integrated into the outside part 104, as the transmission is within the wireless access point 102 itself.

In various implementations, transmissions sent for the outside part 104 may also include credentials from a SIM or eSIM, which may be located in the outside part 104, inside part 106, or partially in each. Such credentials may be retrieved and included in the transmission before it is sent to the base station 114.

Communication through the window 108 relies on light emission and detection or laser emission and detection for ultrafast data transmission. The light or laser and the components creating and recording them may constitute the connection mechanism 120 shown in FIG. 1. No part of the intervening window 108 needs be modified, removed, replaced, etc.

In some implementations, the charge may also be conveyed through the window 108 without any modifications to the window 108. The charge may be received at the inside part 106, conveyed by the inside part 106 through the window 108 to the outside part 104 and used, stored, or both by the outside part 104. The source of the charge received by the inside part 106 may be batteries (as described further herein), a charge cord, inductive charge, etc.

In various implementations, the wireless access point 102 may be the hub of a security service, e.g., a home security service, connected to security cameras such as security cameras 122a and 122b. Other services, such as home appliance management services, etc., may also utilize the wireless access point 102 as a hub or router device.

Setting up the wireless access point 102 may be achieved through an application downloaded on a UE or computer or through a website, with the application or website providing instructions for attaching the outside part 104 and inside part 106. The application or website may also help identify an optimal window location based on, e.g., signal strength of the base station 114, number of devices 118/security cameras 122a and 122b that can be detected at once, or a combination of such factors. In some implementations, the application or website may also determine if a window is suitable based on its clarity/window type. In further implementations, the application or website may also be used for managing the wireless access point 102, managing settings and other aspects of the device.

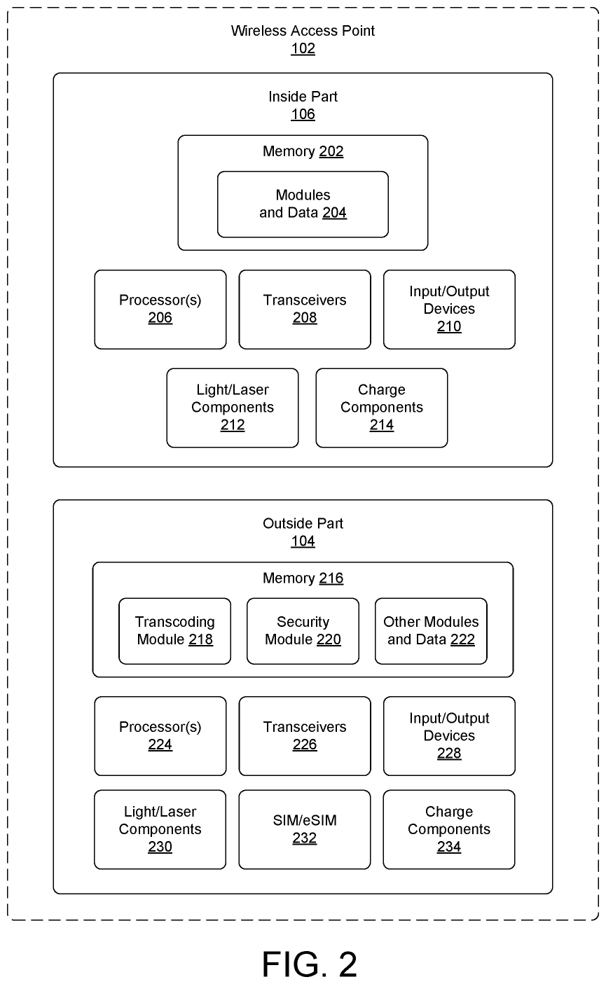

FIG. 2 is a schematic diagram of an example system architecture of a multipart wireless access point with a part inside a building and a part outside of the building, both attached to a window of the building opposite each other. The wireless access point 102 is shown as a dotted line box comprising the inside part 106 and outside part 104. This is because the wireless access point 102 is the combination of the inside part 106 and outside part 104; that is, it is a logical representation of the two of those parts as a single operating unit. As shown, the inside part 106 includes a memory 202 storing modules and data 204, as well as processor(s) 206, transceivers 208, input/output devices 210, light/laser components 212, and charge components 214. The outside part 104 includes a memory 216 storing a transcoding module 218, a security module 220, and other modules and data 222. The outside part 104 also includes processor(s) 224, transceivers 226, input/output devices 228, light/laser components 230, SIM/eSIM 232, and charge components 234.

In various examples, the memory 202 can include system memory, which may be volatile (such as RAM), non-volatile (such as ROM, flash memory, etc.) or some combination of the two. The memory 202 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store the desired information and which can be accessed by the inside part 106 of the wireless access point 102. Any such non-transitory computer-readable media may be part of the inside part 106 of the wireless access point 102.

The memory 202 can include one or more software or firmware elements, such as computer-readable instructions that are executable by the one or more processors 206. For example, the memory 202 can store computer-executable instructions associated with modules and data 204. The modules and data 204 can include a platform, operating system, and applications, and data utilized by the platform, operating system, and applications. Further, the modules and data 204 can implement any of the functionality for the inside part 106 described and illustrated herein. In some examples, the modules and data 204 may also implement some or all of the functionality described for the outside part 104.

In various examples, the processor(s) 206 can be a CPU, a graphics processing unit (GPU), or both CPU and GPU, or any other type of processing unit. Each of the one or more processor(s) 206 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 206 may also be responsible for executing all computer applications stored in the memory 202, which can be associated with types of volatile (RAM) and/or nonvolatile (ROM) memory.

The transceivers 208 can include modems, interfaces, antennas, Ethernet ports, cable interface components, and/or other components that perform or assist in exchanging wireless communications, wired communications, or both.

While the inside part need not include input/output devices 210, in some implementations it may include one, some, or all of these. For example, the input/output devices 210 can include a display, such as a liquid crystal display or any other type of display. For example, the display may be a touch-sensitive display screen and can thus also act as an input device or keypad, such as for providing a soft-key keyboard, navigation buttons, or any other type of input. The input/output devices 210 can include any sort of output devices known in the art, such as a display, speakers, a vibrating mechanism, and/or a tactile feedback mechanism. Output devices can also include ports for one or more peripheral devices, such as headphones, peripheral speakers, and/or a peripheral display. The input/output devices 210 can include any sort of input devices known in the art. For example, input devices can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

In various implementations, the inside part 106 includes light/laser components 212, such as light/laser emitting components and light/laser detecting components disposed on a window-facing surface of the inside part 106 to communicate data with the outside part 104 through the window.

In some implementations, the charge components 214 may include a battery, rechargeable or single charge, integrated into or attached to the inside part 106. Alternatively or additionally, the charge components 214 may include a port for a charging cord plugged into an electrical socket, a port for a cable plugged into another electronic device, or a surface for receiving inductive charge through an inductive charger placed against that surface. The charge components 214 may also include window-facing components for conveying charge through the window to the outside part 104.

In various examples, the memory 216 can include system memory, which may be volatile (such as RAM), non-volatile (such as ROM, flash memory, etc.) or some combination of the two. The memory 216 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, DVD or other optical storage, magnetic cassettes, magnetic tape, magnetic disk storage or other magnetic storage devices, or any other non-transitory medium which can be used to store the desired information and which can be accessed by the outside part 104 of the wireless access point 102. Any such non-transitory computer-readable media may be part of the outside part 104 of the wireless access point 102.

The memory 216 can include one or more software or firmware elements, such as computer-readable instructions that are executable by the one or more processors 224. For example, the memory 216 can store computer-executable instructions associated with the transcoding module 218 and the security module 220. The transcoding module 218 may transcode between the unlicensed frequency and the radio frequency, and visa-versa. The security module 220 may secure transmissions to the telecommunications network across multiple layers of a network stack, such as the physical layer, the link layer, the network layer, the application layer, etc. In other implementations, one or both of the transcoding module 218 and the security module 220 may be implemented entirely or partially in the inside part 106. The other modules and data 222 can include a platform, operating system, and applications, and data utilized by the platform, operating system, and applications. Further, the other modules and data 222 can implement any of the functionality for the outside part 104 described and illustrated herein. In some examples, the other modules and data 222 may also implement some or all of the functionality described for the inside part 106.

In various examples, the processor(s) 224 can be a CPU, a GPU, or both CPU and GPU, or any other type of processing unit. Each of the one or more processor(s) 224 may have numerous ALUs that perform arithmetic and logical operations, as well as one or more CUs that extract instructions and stored content from processor cache memory, and then executes these instructions by calling on the ALUs, as necessary, during program execution. The processor(s) 224 may also be responsible for executing all computer applications stored in the memory 216, which can be associated with types of volatile (RAM) and/or nonvolatile (ROM) memory.

The transceivers 226 can include modems, interfaces, antennas, and/or other components that perform or assist in exchanging wireless communications, wired communications, or both.

While the outside part 104 need not include input/output devices 228, in some implementations it may include one, some, or all of these. For example, the input/output devices 228 can include a display, such as a liquid crystal display or any other type of display. For example, the display may be a touch-sensitive display screen and can thus also act as an input device or keypad, such as for providing a soft-key keyboard, navigation buttons, or any other type of input. The input/output devices 228 can include any sort of output devices known in the art, such as a display, speakers, a vibrating mechanism, and/or a tactile feedback mechanism. Output devices can also include ports for one or more peripheral devices, such as headphones, peripheral speakers, and/or a peripheral display. The input/output devices 228 can include any sort of input devices known in the art. For example, input devices can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism. Further, the input/output devices 228 can include security camera(s) 122a, which are described herein in greater detail.

In various implementations, the outside part 104 includes light/laser components 230, such as light/laser emitting components and light/laser detecting components disposed on a window-facing surface of the outside part 104 to communicate data with the inside part 106 through the window.

In further implementations, the outside part 104 includes a SIM or eSIM 232 which provides credentials for the telecommunications network when the outside part 104 is sending transmissions to the base station. In other implementations, the SIM or eSIM 232 may be placed in the inside part 106 and the credentials may be communicated between the inside part 106 and the outside part 104.

In some implementations, the charge components 234 may include window-facing components for receiving charge through the window from the inside part 106. The charge components 234 may also include an internal battery for storing the received charge.

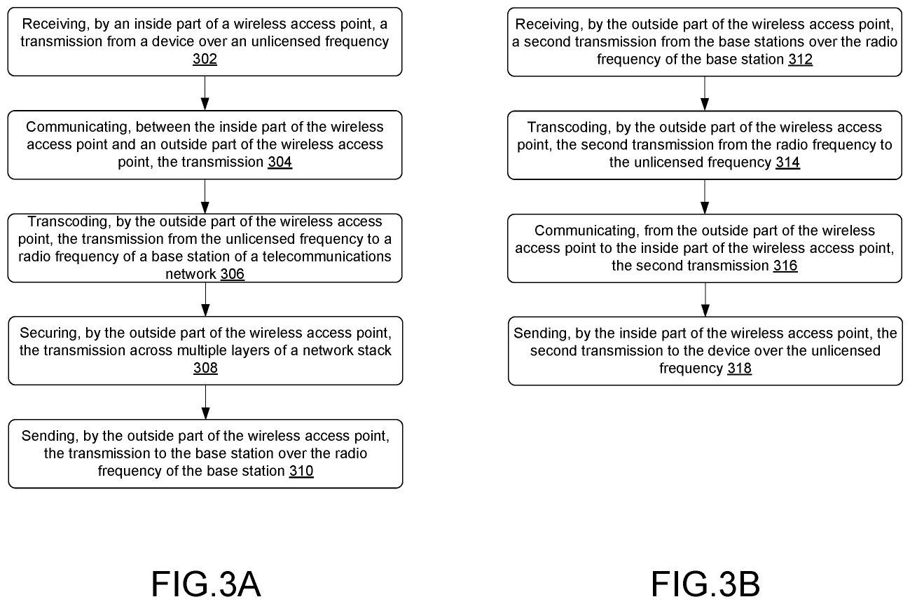

FIGS. 3A-3B illustrate example processes. These processes are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be omitted or combined in any order and/or in parallel to implement the processes.

FIGS. 3A-3B are flow diagrams of illustrative processes for uplink and downlink transmission, transcoding, and securing by a multipart wireless access point with a part inside a building and a part outside of the building, both attached to a window of the building opposite each other. In FIG. 3A, at 302, an inside part of a wireless access point receives a transmission from a device over an unlicensed frequency. Both the inside part and the device are disposed inside a building and the inside part is fixed to a window of the building.

At 304, the inside part of the wireless access point communicates the transmission to an outside part of the wireless access point. The outside part is fixed to the window of the building on an opposite side from the inside part and is disposed outside of the building. Both the inside part and the outside part may be affixed to the window by adhesive mechanisms. In some implementations, the communicating may comprise communicating between the inside part and the outside part using one of light emitting and detecting components or laser emitting and detecting components. Such components may be integrated into the inside part and the outside part of the wireless access point.

At 306, the outside part of the wireless access point transcodes the transmission from the unlicensed frequency to a radio frequency of a base station of a telecommunications network.

At 308, the outside part of the wireless access point secures the transmission across multiple layers of a network stack.

At 310, the outside part of the wireless access point sends the transmission to the base station over the radio frequency of the base station.

In FIG. 3B, at 312, the outside part of the wireless access point receives a second transmission from the base stations over the radio frequency of the base station.

At 314, the outside part of the wireless access point transcodes the second transmission from the radio frequency to the unlicensed frequency.

At 316, the outside part of the wireless access point communicates the second transmission to the inside part of the wireless access point.

At 318, the inside part of the wireless access point sends the second transmission to the device over the unlicensed frequency.

In some examples, the outside part of the wireless access point receives a transmission from a security camera disposed outside the building or integrated within the outside part itself. The outside part may then transcode the transmission from the security camera, if needed, for communication towards the device inside the building or towards the base station. If to be communicated towards the base station, the outside part may also secure the transmission from the security camera before sending it on. Further, when the security camera is integrated into the outside part, all transmission prior to sending to the base station is internal to the wireless access point, providing an even greater level of security.

In further implementations, the inside part of the wireless access point may receive a charge through a charging port of the inside part and transmit the charge through the window to the outside part of the wireless access point. The charge may be provided by a battery integrated into the inside part, by a charging cord plugged into an electrical socket, by a cable plugged into another electronic device, or by inductive charge through an inductive charger placed against an outer surface of the inside part.

The wireless access point may also include an Ethernet port (e.g., on the inside part) or a SIM or eSIM (integrated in the inside part or the outside part).

Additionally, the device that the transmission is received from and that the second transmission is sent to may be a security camera. In such implementations, the wireless access point may serve as a hub for a security service for the building. In other examples, the device may be one of a plurality of devices communicating through the wireless access point to the telecommunications network. In such other examples, the outside part of the wireless access point may be configured to prioritize transmissions to or from different ones of the devices based on device types associated with the devices or content types associated with the transmissions. The plurality of devices in such examples may include a security camera, an Internet-of-Things device, a media player, a computing device, or a UE.

In various implements, the wireless access point may be managed by an application of a UE. The application may provide set-up guidance for installing the wireless access point. The set-up guidance may include capabilities for identifying signal strengths at possible installation sites around the building. The application may also include capabilities for determining whether a window is suitable for installation.

Although features and/or methodological acts are described above, it is to be understood that the appended claims are not necessarily limited to those features or acts. Rather, the features and acts described above are disclosed as example forms of implementing the claims.

What is claimed is:

1. A wireless access point, comprising:
a first part disposed outside of a building, the first part transmitting to and receiving from a base station of a telecommunications network over a radio frequency of the base station and transcoding between a signal associated with the radio frequency and a signal associated with an unlicensed frequency;
a second part disposed inside of the building, on a opposite side of a window of the building from the first part, the second part transmitting to and receiving from one or more devices disposed within the building over the unlicensed frequency and receiving a charge from a power component coupled to the second part; and
a connection mechanism for transmitting and receiving data between the first part and the second part and for transmitting the charge from the second part to the first part,
wherein the transmitting from the first part to the base station is secured across multiple layers of a network stack.

2. The wireless access point of claim 1, wherein the one or more devices disposed within the building include at least a security camera, an Internet-of-Things device, a media player, a computing device, or a user equipment (UE).

3. The wireless access point of claim 1, wherein the connection mechanism for transmitting and receiving the data between the first part and the second part is one of light emitting and detecting components or laser emitting and detecting components.

4. The wireless access point of claim 1, wherein at least one of the first part and the second part is attached to the window by an adhesive mechanism.

5. The wireless access point of claim 1, further comprising a subscriber identity module (SIM) or an embedded SIM (eSIM) disposed within the first part or the second part and configured to provide identity information for the wireless access point to the telecommunications network.

6. The wireless access point of claim 1, further comprising an Ethernet port disposed on a surface of the second part for wireline communications with the one or more devices.

7. The wireless access point of claim 1, wherein the wireless access point is configured to serve as a hub device for one or more security cameras disposed on the first part of the wireless access point, on the building, or in proximity to the building and provide a security monitoring service.

8. The wireless access point of claim 1, wherein the wireless access point is managed by an application of a user equipment (UE).

9. The wireless access point of claim 8, wherein the application provides set-up guidance for installing the wireless access point, the set-up guidance including capabilities for identifying signal strengths at possible installation sites around the building.

10. The wireless access point of claim 9, wherein the application includes capabilities for determining whether a window is suitable for installation.

11. A method comprising:
receiving, by an inside part of a wireless access point, a transmission from a device over an unlicensed frequency, wherein both the inside part and the device are disposed inside a building and the inside part is fixed to a window of the building;
communicating, between the inside part of the wireless access point and an outside part of the wireless access point, the transmission, wherein the outside part is fixed to the window of the building on an opposite side from the inside part and is disposed outside of the building;
transcoding, by the outside part of the wireless access point, the transmission from the unlicensed frequency to a radio frequency of a base station of a telecommunications network;
securing, by the outside part of the wireless access point, the transmission across multiple layers of a network stack; and
sending, by the outside part of the wireless access point, the transmission to the base station over the radio frequency of the base station.

12. The method of claim 11, further comprising:
receiving, by the outside part of the wireless access point, a second transmission from the base station over the radio frequency of the base station;
transcoding, by the outside part of the wireless access point, the second transmission from the radio frequency to the unlicensed frequency;
communicating, from the outside part of the wireless access point to the inside part of the wireless access point, the second transmission; and
sending, by the inside part of the wireless access point, the second transmission to the device over the unlicensed frequency.

13. The method of claim 11, further comprising receiving, at the outside part of the wireless access point, a transmission from a security camera disposed outside the building as part of the outside part or remote from the outside part.

14. The method of claim 11, wherein the communicating comprises communicating between the inside part and the outside part using one of light emitting and detecting components or laser emitting and detecting components.

15. The method of claim 11, further comprising:
receiving, by the inside part of the wireless access point, a charge through a charging port of the inside part; and
transmitting, by the inside part of the wireless access point to the outside part of the wireless access point, the charge through the window.

16. The method of claim 11, wherein the device is a security camera and the wireless access point serves as a hub for a security service for the building.

17. The method of claim 11, wherein the device is one of a plurality of devices communicating through the wireless access point to the telecommunications network, and the outside part of the wireless access point is configured to prioritize transmissions to or from different ones of the devices based on device types associated with the devices or content types associated with the transmissions.

18. One or more non-transitory computer storage media having programming instructions stored thereon that, when executed by processor(s) of a wireless access point, cause the wireless access point to perform operations comprising:
receiving, by an inside part of the wireless access point, a transmission from a device over an unlicensed frequency, wherein both the inside part and the device are disposed inside a building and the inside part is fixed to a window of the building;
communicating, between the inside part of the wireless access point and an outside part of the wireless access point, the transmission, wherein the outside part is fixed to the window of the building on an opposite side from the inside part and is disposed outside of the building;
transcoding, by the outside part of the wireless access point, the transmission from the unlicensed frequency to a radio frequency of a base station of a telecommunications network;
securing, by the outside part of the wireless access point, the transmission across multiple layers of a network stack; and
sending, by the outside part of the wireless access point, the transmission to the base station over the radio frequency of the base station.

19. The one or more non-transitory computer storage media of claim 18, wherein the device is a security camera and the wireless access point serves as a hub for a security service for the building.

20. The one or more non-transitory computer storage media of claim 18, wherein the device is one of a plurality of devices communicating through the wireless access point to the telecommunications network, and the outside part of the wireless access point is configured to prioritize transmissions to or from different ones of the devices based on device types associated with the devices or content types associated with the transmissions.
